(19) United States
(12) Patent Application Publication
(10) Pub. No.: US 2009/0233046 A1
(43) Pub. Date: Sep. 17, 2009

(54) Apertured nonwoven webs with lined apertures

(75) Inventor: Lino Iulianetti, Torre dei Passeri (Pescara) (IT)

Correspondence Address: Tessari & Associates, PLLC, 215 N. Olive Sreet, Media, PA, 19063, US

(73) Assignee: Tredegar Film Products Corporation, Richmond, VA (US)

(21) Appl. No.: 12/380,834

(22) Filed: Mar. 4, 2009

Related U.S. Application Data
(60) Provisional application No. 61/069,016, filed on Mar. 11, 2008.

(51) Int. Cl. B32B 3/10; B32B 38/04

(52) U.S. Cl. 428/137; 156/250

(57) ABSTRACT

Apertured nonwoven webs are disclosed wherein the apertures in the web are treated with an active substance such that the inner surface of the aperture differs in properties, characteristics or appearance from a surface of the web adjacent to the aperture.

### BACKGROUND OF THE DISCLOSURE

The disclosure relates to apertured nonwoven webs, and in particular to apertured nonwoven webs having apertures lined with an active material.

Nonwoven webs have been used in the prior art for numerous applications. For example, the use of nonwoven webs at in disposable absorbent articles such as diapers, feminine hygiene products and adult incontinent products is known. Nonwoven webs are also known for use in disposable apparel, such as limited use panties or coveralls; in medical applications such as drapes and absorbent pads; for industrial applications such as housewrap, roof underlayment and carpet backing; for personal care applications such as wipes; and in numerous other applications.

Apertured nonwoven webs are also known and have found particular utility as topsheets and transfer layers in disposable absorbent articles and personal care applications as mentioned above. A variety of methods are known for making apertured nonwoven webs. One such method utilizes a pin roller having a plurality of needle-like projections on its circumference and a mating roller having a plurality of recesses adapted and arranged to receive the projections as the rollers engage one another. As the nonwoven web is passed between the nip formed by the pin roller and the mating roller, the pins perforate the web. In one variation on this method, one or both of the rollers may be heated and the speed of the aperturing process and temperature of the roller(s) is such that a cone-shaped aperture is formed in the web. The cone-shaped aperture protrudes beyond the plane of the web, creating what is known in the art as a three-dimensional apertured nonwoven web. An exemplary process of making a three-dimensional apertured nonwoven web is disclosed in US Published Patent Application No. 200300085213, the disclosure of which is incorporated herein by reference.

In some applications, it may be desired to apply an active substance to a nonwoven web to change the appearance, the properties, or the characteristics of the web in the locations where the substance is applied. For example, it is known in the art to apply a surfactant to a nonwoven web to change its relative hydrophobicity. Likewise, it is known to apply an ink to a nonwoven web to create a graphic image on the web or other wise to change its appearance. In all instances, the substance is applied in a separate step after the web is formed, and, to the knowledge of the present inventor, is always independent of the any process to form apertures in the web.

### SUMMARY OF THE DISCLOSURE

In one embodiment, the disclosure provides a nonwoven web comprising a plurality of apertures, wherein at least one aperture has an inner surface that differs in properties, characteristics or appearance from a surface of the web adjacent to the aperture.

In one embodiment, the disclosure provides a nonwoven web comprising a plurality of apertures, wherein at least one aperture has an inner surface that is more hydrophilic than a surface of the web adjacent to the aperture.

In another embodiment, the disclosure provides an nonwoven web having a first surface and a second surface, the web comprising a plurality of apertures originating at the first surface of the web and terminating in a plane spaced from both the first and second surface of the web, wherein at least one aperture has an inner surface that differs in properties, appearance or characteristics from a surface of the web adjacent to the aperture.

In another embodiment, the disclosure provides an nonwoven web having a first surface and a second surface, the web comprising a plurality of apertures originating at the first surface of the web and terminating in a plane spaced from both the first and second surface of the web, wherein at least one aperture has an inner surface that is more hydrophilic than a surface of the web adjacent to the aperture.

In another embodiment, the disclosure provides an nonwoven web having a first surface and a second surface, the web comprising a plurality of apertures originating at the first surface of the web and terminating in a plane spaced from both the first and second surface of the web, wherein at least one aperture has an inner surface that differs in color from a surface of the web adjacent to the aperture.

In another embodiment, the disclosure provides laminates comprising a nonwoven web bonded to a second web, wherein the laminate comprises a plurality of apertures, wherein an inner surface of at least one aperture differs in properties, appearance or characteristics from a surface of the web adjacent to the aperture. In some embodiments, the second web may be a nonwoven or a film. In some embodiments, the apertures may comprise cone-shaped apertures that protrude beyond the surface of the laminate, whereby the laminate comprises a three-dimensional laminate.

These and other features of the disclosure will become apparent upon a further reading of the specification with reference to the drawings, and the claims.

### BRIEF DESCRIPTION OF THE DRAWING FIGURES

FIG. 1 is a sectioned side view of an absorbent article employing a web produced in accordance with the disclosure.

FIG. 2 is a side view, partly in section, illustrating one method of aperturing a nonwoven web in accordance with the disclosure.

FIG. 3 is a perspective view of an apparatus that may be used to prepare the webs of the disclosure.

### DETAILED DESCRIPTION

As is known in the art, nonwoven webs are fibrous webs comprised of polymeric fibers arranged in a random or non-repeating pattern. For most of the nonwoven webs, the fibers are formed into a coherent web by any one or more of a variety of processes, such as spunbonding, meltblowing, bonded carded web processes, hyrdoentangling, etc., and/or by bonding the fibers together at the points at which one fiber touches another fiber or crosses over itself. The fibers used to make the webs may be a single component or a bi-component fiber as is known in the art and furthermore may be continuous or staple fibers.

Term “meltblown fibers” refers to fibers formed by extruding a molten thermoplastic material through a plurality of fine, usually circular, die capillaries as molten threads or filaments into a high velocity gas (e.g., air) stream that attenuates the filaments of molten thermoplastic material to reduce their diameter, which may be to a microfiber diameter. The term “microfibers” refers to small diameter fibers having an average diameter not greater than about 100 microns. Thereafter, the meltblown fibers are carried by the high velocity gas stream and are deposited on a collecting surface to form a web of randomly dispersed meltblown fibers.

The term “spunbonded fibers” refers to small diameter fibers that are formed by extruding a molten thermoplastic material as filaments from a plurality of fine, usually circular, capillaries of a spinneret with the diameter of the extruded filaments then being rapidly reduced as by, for example, eductive drawing or other well-known spunbonding mechanisms.

The term “unconsolidated” means the fibers have some freedom of movement and are not fixed in position with respect to the other fibers in the web. In other words, the fibers generally are not compacted together or fused to the extent that an aperture cannot close, rather, the aperture may be blocked by some fiber strands that extend across, and partially obstruct it.

By contrast, the term “consolidated” means the fibers are generally compacted, fused, or bonded, so as to restrict movement of the fibers individually. Consolidated fibers will generally not extend out into an aperture and will likely have a higher density than unconsolidated fibers.

The term “unitary web” refers to a layered web comprising two or more webs of material, including nonwoven webs, that are sufficiently joined, such as by thermal bonding means, to be handled, processed, or otherwise utilized, as a single web.

Terms “laminate” and “composite”, when used to describe webs of the present disclosure, are synonymous. Both refer to a web structure comprising at least two webs joined in a face to face relationship to form a multiple-layer unitary web.

The term “polymer” includes homopolymers, copolymers, such as, for example, block, graft, random and alternating copolymers, terpolymers, etc., and blends and modifications thereof. Furthermore, unless otherwise specifically limited, the term “polymer” is meant to include all possible geometrical configurations of the material, such as isotactic, syndiaotactic and random symmetries.

The term “substantially” means that a given property or parameter may vary by about 20% from the stated value.

Throughout this description, the expressions “topsheet” and “backsheet” denote the relationship of these materials or layers with respect to the absorbent core. It is understood that additional layers may be present between the absorbent core and the topsheet and backsheet, and that additional layers and other materials may be present on the side opposite the absorbent core from either the topsheet or the backsheet.

The term “formed film” refers to a resilient three dimensionally formed film similar in structure to that produced by vacuum forming processes, as described in U.S. Pat. No. 4,456,570 to Thomas or U.S. Pat. No. 3,929,135 to Thompson, among others.

The terms “active substance” and “active material” are used interchangeably and denote a substance that, when applied to the linings of the apertures, will result in a change in properties, characteristics or appearance of the web. The active substance can be in any suitable form that will permit it to be transferred from the pins to the web in accordance with this disclosure. Liquids, semi-liquids (e.g., paste) and solids (e.g., powders) are contemplated hereunder. By way of example only, a surfactant as an active substance would change the properties of the aperture lining by changing the relative hydrophobicity. Likewise, a paint or ink would change the appearance of the web. A sizing agent may be applied to change the characteristics of the aperture lining, such as by changing the rigidity of the aperture, or by forming a film-like surface on the interior of the aperture. Mixtures of active substances may also be used to provide, for example, a change in both color and surface energy.

### Exemplary Embodiment

For convenience of the reader, this disclosure will focus on the embodiment where the inner surface of the apertures is rendered more hydrophilic than the surface of the web as an exemplary embodiment. It will be apparent to the reader and those skilled in the art, however, that liquids other than surfactants can be applied to the webs to change the properties, characteristics or appearance of the inner surface of the aperture as compared to the surface of the web adjacent to the aperture.

In one embodiment, the apertured webs disclosed herein comprise a nonwoven web having a plurality of apertures, wherein at least one of the apertures has an inner surface that differs in properties, appearance or characteristics from a surface of the web adjacent to the aperture. In one embodiment, the inner surface of at least one aperture is more hydrophilic than the surface of the web.

In one embodiment, the apertured webs disclosed herein comprise a nonwoven web having a plurality of apertures, wherein at least one of the apertures has an inner surface that differs in properties, appearance or characteristics from a surface of the web adjacent to the aperture. In one embodiment, the inner surface of at least one aperture is more hydrophilic than the surface of the web. These embodiments are particularly beneficial for use in the hygiene area, in particular as topsheets in baby or adult diapers, feminine hygiene products, bandages and other similar applications.

The polymers used to make the fibers in nonwoven webs, and thus the webs themselves, are naturally hydrophobic. For applications such as topsheets and transfer layers in absorbent articles, it is important for the webs to have the right liquid transport and liquid management properties. Thus, it is known in the art to incorporate surfactants into the web to render the web hydrophilic, or at least more hydrophilic (less hydrophobic), than the web would be without the surfactant. The surfactant may be incorporated into the web either in the polymer composition used to make the fibers or by treatment of the web after it is formed. By rendering the web more hydrophilic, the web becomes wettable to facilitate the movement of liquids, such as urine or menses, toward the absorbent core in such articles.

In order to compensate for the tendency of conventional surface treatments to rub off, conventional surface treatments are often applied to the polymeric fabrics in large quantities. Heavy applications lead to increased costs. Further, such levels of surfactants have been known to cause skin irritation in some individuals, particularly those with sensitive skin. Generally, surfactant levels as high as 1% by weight of the treated portion of the topsheet, and more specifically between 0.3% and 0.6% by weight of the treated portion of the topsheet, have been used. In the past, it was generally believed that applications any less than these would not permit adequate wetting of the topsheet.

While hydrophilic properties of a nonwoven web used as a topsheet, for example, are desired, it is not necessarily desired for the entire web to be rendered hydrophilic. Indeed, it is often the case that fluid transport properties are enhanced by providing a hydrophobic gradient in the web. The gradient creates a driving force to move the fluids from one region to another, such as from a hydrophobic region to a hydrophilic region, or from a hydrophilic region to a more hydrophilic region, or from a hydrophobic region to a less hydrophobic region.

Moreover, when the surface of the web, particularly the land areas between the apertures, is hydrophilic, the space between the fibers tends to hold liquids. Any liquids held near the surface of the web can create a feeling of discomfort for the user. In addition, if the web could be rendered more hydrophilic only where needed, that would reduce the expense of using the surfactant and the risk of irritation to certain consumers. See, for example, U.S. Pat. No. 3,730,184; U.S. Pat. No. 4,112,153; U.S. Pat. No. 4,328,279; U.S. Pat. No. 4,585,449; U.S. Pat. No. 4,950,264; U.S. Pat. No. 4,861,652; U.S. Pat. No. 5,562,650; U.S. Pat. No. 5,330,456; U.S. Pat. No. 5,486,381; U.S. Pat. No. 5,057,361; U.S. Pat. No. 5,620,788; U.S. Pat. No. 5,980,814; U.S. Pat. No. 6,599,575; and WO 2000/066058, the disclosures of which are incorporated herein by reference.

The thermoplastic materials, and in particular the thermoplastic fibers, can be made from a variety of thermoplastic polymers, including polyolefins such as polyethylene and polypropylene, polyesters, copolyesters, polyvinyl acetate, polyamides, copolyamides, polystyrenes, polyurethanes and copolymers of any of the foregoing such as vinyl chloride/vinyl acetate, and the like. Suitable thermoplastic fibers can be made from a single polymer (monocomponent fibers), or can be made from more than one polymer (e.g., bicomponent fibers). For example, “bicomponent fibers” can refer to thermoplastic fibers that comprise a core fibre made from one polymer that is encased within a thermoplastic sheath made from a different polymer. The polymer comprising the sheath often melts at a different, typically lower, temperature than the polymer comprising the core. As a result, these bicomponent fibers provide thermal bonding due to melting of the sheath polymer, while retaining the desirable strength characteristics of the core polymer.

Suitable bicomponent fibers can include sheath/core fibers having the following polymer combinations: polyethylene/polypropylene, polyethylvinyl acetate/polypropylene, poly-ethylene/polyester, polypropylene/polyester, copolyester/polyester, and the like. The bicomponent fibers can be concentric or eccentric, referring to whether the sheath has a thickness that is even, or uneven, through the cross-sectional area of the bicomponent fibre. Eccentric bicomponent fibers can be desirable in providing more compressive strength at lower fibre thicknesses.

In the case of thermoplastic fibers, their length can vary depending upon the particular melt point and other properties desired for these fibers. Typically, these thermoplastic fibers have a length from about 0.3 to about 7.5 cm long, preferably from about 0.4 to about 3.0 cm long. The properties, including melt point, of these thermoplastic fibers can also be adjusted by varying the diameter (caliper) of the fibers. The diameter of these thermoplastic fibers is typically defined in terms of either denier (grams per 9000 meters) or decitex (grams per 10,000 meters). Depending on the specific arrangement within the structure, suitable thermoplastic fibers can have a decitex in the range from well below 1 decitex, such as 0.4 decitex, up to about 20 decitex.

In order to give certain strength and integrity properties to the web structures, these are generally bonded. The most broadly used technologies are (a) chemical bonding or (b) thermo bonding by melting a part of the web. For the latter, the fibers can be compressed, resulting in distinct bonding points, which, for example for nonwoven materials, can cover a significant portion of the total area. Or, particularly useful for structures where low densities are desired, “air-through” bonding can be applied, where parts of the fibers; e.g., the sheath material of a bicomponent fibers, are partially melted by means of heated air passing through the (often air-laid) web. As the web is cooled, the partially melted fibers bond to one another where they touch.

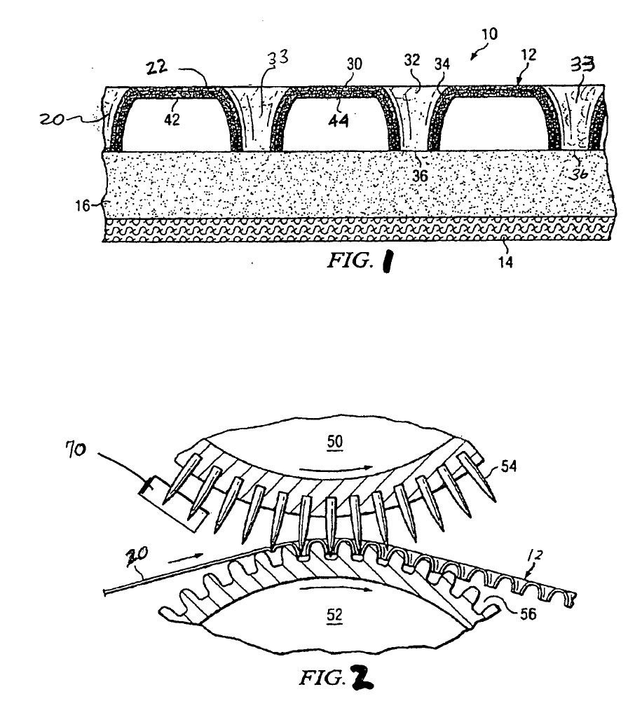

With reference to FIG. 1, a sectioned view of an absorbent article 10 is illustrated therein. The absorbent article 10 comprises a topsheet 12, a backsheet 14 and an absorbent core 16 positioned between the topsheet 12 and the backsheet 14. The backsheet 14 and the absorbent core 16 arc not particularly critical to the present disclosure and, consequently, can comprise any of the known materials, and combination of materials, known in the art for that particular use and purpose.

The topsheet 12 comprises a laminated apertured nonwoven web 20, formed from an upper nonwoven web 30 bonded to a lower nonwoven web 42. In the embodiment shown, a plurality of apertures 32 extend through nonwoven web 20.

The apertures 32 have an inner surface 33, through which fluids, such as urine, are transported from the body side surface 22 to the absorbent core 16. In accordance with the disclosure, the inner surface 33 of apertures 32 is more hydrophilic as compared to other portions of the web 20. In one embodiment, the inner surface 33 of apertures 32 comprises a surfactant whereas the remainder of the web 20 is substantially free of surfactant. In one embodiment, the web 20 is hydrophobic, except that the inner surface 33 of apertures 32 is hydrophilic.

The apertures 32 are generally conical, having a larger opening 34 and a smaller opening 36. In particular, the larger opening 34 is located on the surface of the web that would be adjacent to the user of the absorbent article, which is generally referred to in the art as the body facing surface 22. The smaller opening 36 in the aperture 32 is positioned at the end of the cone-shaped aperture and spaced from the body facing surface 22 as well as the underside surface 44 of the laminated nonwoven web 20. The spaced relationship between the smaller opening 36 and the underside surface 44 of the web 30 creates what is termed in the art as a “three-dimensional” web. In some embodiments, the fibers near the larger opening 34 are substantially unconsolidated and the fibers near the smaller opening 36 are substantially consolidated.

In an embodiment the nonwoven web is an airthrough bonded, carded thermobonded, spunbonded, or spunbond-meltblown-spunbond nonwoven. In one embodiment, the nonwoven is a carded thermobonded web. For hygiene applications, carded thermobonded nonwoven webs such as those commercially available from Shalag Shamir in Israel are useful. In an embodiment, the fibers are single component or bi-component. In most cases, the nonwoven will comprise a polyolefin fiber, such as polypropylene or polyethylene. However, webs made of polyester and combinations of polyolefin and polyester are also possible. The basis weight (i.e., weight per unit area) of the nonwoven web is not critical and can be determined based on the intended use of the web and whether the web is a single layer web or a laminate. For hygiene applications, webs of 20-30 grams/m² (“GSM”) are satisfactory, more preferably 22-26 GSM.

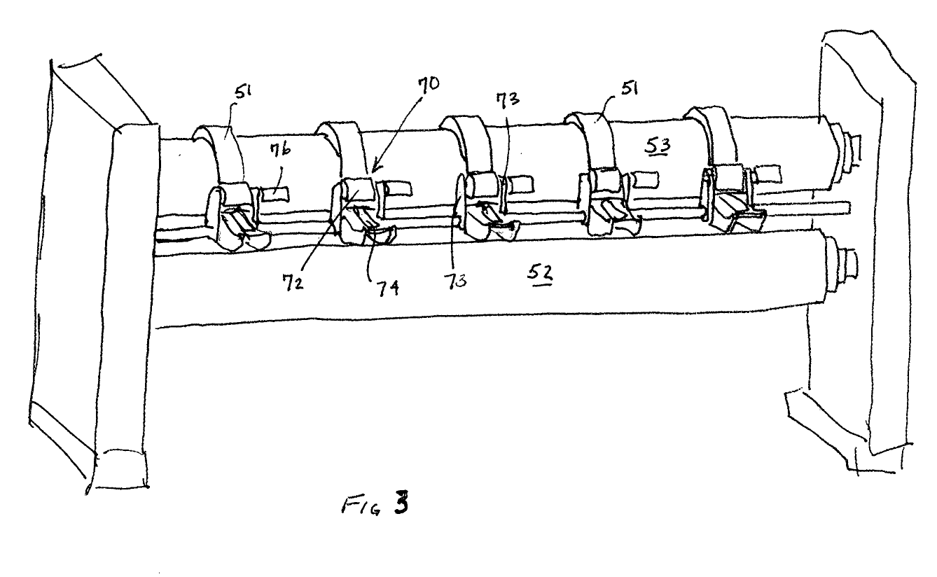

FIG. 2 shows a preferred mechanism for forming apertures 32. A pin roll 50 and counter roll 52 rotate in opposite directions to form a nip through which the nonwoven web 20 is fed. Pins 54 protrude from the surface of pin roll 50. Holes 56 are recessed into counter roll 52. Pin roll 50 and counter roll 52 are aligned so that pins 54 mate with holes 56. As the web 30 passes through the nip, the pins 54 penetrate the web and enter the corresponding holes 56. As is known, this can result in the formation of the three-dimensional cone shaped apertures depicted in the Figures, or can result in a simple perforation of the web, depending on the nip setting, roller speed, temperature, and other factors.

The holes 56 may be larger than pins 54 and may be shaped. In one embodiment the shape of holes 56 is partially replicated by the apertures 32. In one embodiment the holes 56 are generally conical so that when the pins 54 push material into holes 56 the material near the tips of pins 54 is compressed further than any other material, and experiences more heat transfer if the pins 54 are heated. This combination of narrow heated pins 54 and generally conical holes 56 produces a aperture 32 having generally consolidated fibers near a smaller opening 36 and generally unconsolidated fibers near a larger opening 34.

In the exemplary embodiment for hygiene applications, the depth of the aperture can be between 0.5 mm and 2.0 mm, for example, but this is not particularly critical to the disclosure and any suitable size, shape and depth of the apertures 32 can be employed based on the intended use of the web.

In one embodiment, pin roll 50 and counter roll 52 are manufactured of rigid material and are mounted on an adjustable chassis to allow modification of the distance between the rolls. In one embodiment, pin roll 50 is manufactured of metallic material and pins 54 are manufactured of a metallic material. In one embodiment, pins 54 have a pointed end and taper from about half of their length to the pointed end. In one embodiment pins 54 are heated, as discussed in more detail below. The pin roll may comprise 7, 11, 18 or 22 pins per square centimeter. Pin diameter can range from 1 to about 4 mm, more preferably 1.4 to about—3.1 mm. Pin diameters of 1.4 mm, 2.5 mm or 3.1 mm are preferred. Mixtures of different size pins can also be used. In general, the open area of the web after perforation can be between 5% and 20% for hygiene applications. Other applications may require an open area that is higher or lower than this range.

In another embodiment, counter roll 52 may be manufactured of a pliable material. Depending on the pliability of the counter roll, holes 56 may be unnecessary because the pins 54 could simply protrude into the pliable material of counter roll 52. In yet another preferred embodiment, the counter roll 52 may be comprised of densely packed bristles, such as a brush roll.

The pins 54 may be heated for several reasons. One reason to heat pins 54 is to properly form apertures 32, particularly three-dimensional apertures as illustrated. The heated pins 54 may also be heated to a temperature sufficient to bond the nonwoven web 30 to another web to form a laminate. Furthermore, the heated pins 54 may help in creating substantially consolidated fibers near the smaller openings 36. The pins may also be heated to provide for structural resilience in large scale apertures 32 in order to maintain void volume between the topsheet 12 and the absorbent core 16 (see FIG. 1).

In some embodiments, and as seen in FIG. 3, it may be desired to use a series of pin rings in lieu of pin roller 50. Using pin rings 51, which would fit over and be secured to a solid roller 53, for example, give the benefit of being able to perforate a web only in desired areas, as oppose to across the entire web.

In accordance with the exemplary embodiment, the inner surface 33 of at least one of the apertures 32 is more hydrophilic than other portions of the web, more specifically the surface of the web adjacent to the aperture. In the exemplary embodiment, the inner surface 33 of apertures 32 comprises a surfactant. The surfactant is applied to the inner surface 33 of apertures 32 by transferring surfactant from the pins 54 to the web as the apertures are formed.

For example, as seen in FIG. 2, the tips of pins 54 enter an active material application zone 70 prior to engaging the web 20 or the holes 56 in the counter roll. In the active material application zone 70, the active material contained therein, whether a surfactant solution, paint, ink, or other substance, is applied to the pins. As the pins 54 penetrate the web 20, the active material is transferred from the pins 54 to the inner surface of the apertures being formed. Thus, the active material is applied only in the areas where the pin touches the web and the unnecessary and undesirable use of surfactant is avoided.

The surfactant may be applied to the pins 54 in zone 70 by any suitable method. For example, zone 70 can comprise a spray device to spray the active material onto the pins 54. In other embodiments, the zone 70 may comprise a sponge or brush applicator which is saturated with the active material and applied to the pins via surface contact transfer. In one embodiment, zone 70 comprises a semi-rigid applicator made of microcellular polyurethane, such as Cellasto® manufactured by BASF. In some embodiments, the active material in zone 70 may be of varying viscosity, and may be in the form of a liquid, a paste, a gel, a powder or other form. The viscosity of the substance being applied will need to be considered in determining the appropriate mechanism to transfer that substance to the pins 54 in zone 70.

In general, it will be advantageous for the application zone to be positioned in close proximity to the nip formed between pin roll 50 (or pin ring 51) and counter roll 52 to minimize loss of material before the web is apertured. In one embodiment, as seen in FIG. 3, the application zone 70 is supported in close proximity to the nip between the pin ring 51 and counter-roll 52. In the embodiment shown, the application zone 70 comprises a transfer applicator 72 supported by brackets 73. A piston or similar device 74 is positioned to urge the applicator into and out of engagement with the pins 54 and/or adjust the position of the applicator 72 relative to the pin rings 51. A reservoir 76 may be provided to replenish the applicator 72.

As noted, in the exemplary embodiment a surfactant is applied to the inner surface 33 of apertures 32. In such an embodiment, the choice of surfactant is not particularly important. Any agent which has the property of increasing the wettability of polymeric fibers can be used. Exemplary surfactants include nonionic surfactants and anionic surfactants. Besides nonionic surfactants, anionic surfactants can also be used. Examples of surfactants include Brij® 76 available from ICI Americas, Inc; various surfactants sold under the Pegosperse® trademark by Glyco Chemical, Inc.; octylphenoxypolyethoxy ethanol; dioctyl sodium sulfosuccinate (sold as TRITON® GR-SM by Union Carbide); a fatty substance (glycerol and/or sorbitol) reacted with lauric acid (available from Ciba Chemical under the Atmer® trademark); Triton® X-200, which is the sodium salt of an alkylaryl polyether sulfonate supplied by Union Carbide; Nu-Wet® supplied by GE Silicones; BK2105® surfactant made by Henkel Corporation; and Silastol® PST by Schill & Seilacher. Non-conventional surfactants, such as the coatings disclosed in WO 2000/066058 and U.S. Pat. No. 6,599,575 may also be employed.

One advantage of the disclosure is that surfactant can be applied only in the apertures of the web. Conventional surfactant treatment of topsheets and distribution layers utilizes enough surfactant so that, when dried, the surfactant comprises 0.3 to 0.5% by weight of the treated portion of the topsheet. Treatments above these levels are believed to provide the potential to cause skin irritation. Even treatment at these levels can cause irritation in sensitive individuals. Webs according to the disclosure can be made in such a way that surfactant is present only in the apertures, thus minimizing the risk of irritation and reducing the costs of manufacture.

### Other Embodiments

In other exemplary embodiments, the selection of the appropriate active material will, of course, be dictated by the desired properties to be imparted to the apertures of the web. If the active substance is a liquid, migration of the liquid or other substance being applied to the aperture linings is something that may need to be taken into account. In particular, it is known that low molecular weight surfactants, for example, may have a tendency to “seep” through the fibers of a nonwoven web. This may result in other areas of the web, such as those areas surrounding the aperture, which may result in such areas having the same properties as the aperture lining. This “seeping” phenomenon may be dependent on the conditions of storage. For example, the seeping may be more prevalent if the web is stored in a roll form (layer-on-layer) and/or under conditions of elevated temperature.

The embodiments described herein included a laminated nonwoven topsheet. The disclosure should not be construed as limited to such an embodiment. For example, a single layer nonwoven web could be used to advantage in lieu of the laminated web depicted in the Figures and discussed above. Likewise, a single layer film material may also be used as the web. In addition, laminates comprising a nonwoven web and a film could also be used in lieu of the nonwoven/nonwoven laminate. Nonwoven/film laminates can comprise thermoplastic films and formed films. Moreover, laminates can comprise more than two layers if desired. In addition, the webs do not need to have the three-dimensional structure depicted in the Figures.

If a laminated web is used, the individual webs can be bonded together by any known method, such as adhesive bonding, ultrasonic bonding, thermal bonding, etc. In one embodiment, the substantially consolidated fibers located near the smaller opening 36 in the apertures 32 forms a bonding point with any additional webs that might be used in the laminate.

The teachings of this disclosure have numerous possible variations from the exemplary embodiment. For example, an active substance can be applied to the aperture lining which will then harden, to reinforce the aperture. The reinforced web would have utility in absorbent articles and in other devices where the integrity of the cone formed during the aperture process was of importance. The active substance could be a lotion, cream, cleaning solution, antiseptic solution or the like which would be deposited in the apertures and then released to a surface. Such webs may be used in wipes, for example. In another embodiment, the active material may be a solid, such as deodorants, activated charcoal, dry inks, and microcapsules containing pharmaceuticals or scents. Such webs could be made to release the active material from the inner surface of the aperture upon application of pressure or under other specified conditions. Solid active materials may be transferred to the inner surface of the aperture by using a slurry of the active material or by applying an electrostatic charge to the pins, for example.

In other contemplated embodiments, the webs in accordance with the disclosure may be used in any application where a fluid (e.g., liquid, gas or fine solid) is made to pass through the apertures. The apertures could then be lined with an active substance that dissolves into or otherwise acts on the fluid. Suitable uses for such webs may be the delivery of agricultural chemicals (e.g., a mulch or weed block fabric); delivery of antimicrobial substances in hygiene products, food packaging, medical wound dressings, water treatment applications, sterilization bags, medical apparel or drapes; delivery of pharmaceuticals; delivery of chemicals (e.g., catalysts, reactants) in process streams, and solid electrolytes in batteries and fuel cells.

1. A nonwoven web having a plurality of apertures, wherein an inner surface of at least one aperture differs in properties, characteristics or appearance from a surface of the web adjacent to the aperture.

2. The web of claim 1, further comprising a web at least one other web selected from a nonwoven and a film.

3. The web of claim 2, wherein the film is selected from flat films and three-dimensional formed films.

4. The web of claim 1, wherein the apertures comprise 20-40% of the total area of the web.

5. (canceled)

6. The web of claim 1, wherein the inner surface of at least some of the apertures comprises a surfactant.

7. The web of claim 6, wherein the surfactant is selected from non-ionic and anionic surfactants.

8. The web of claim 6, wherein the surfactant comprises Silastol® PST.

9. The web of claim 6 wherein the inner surface of the aperture is more hydrophilic than the surface of the web adjacent to the aperture.

10. The web of claim 1, wherein the web is selected from airthrough bonded, carded thermobonded, spunbonded, meltblown, and spunbond-meltblown-spunbond nonwoven webs.

11. (canceled)

12. (canceled)

13. (canceled)

14. An absorbent article comprising the web of claim 1.

15. A method comprising:
a) providing a nonwoven web; and
b) applying a surfactant to an array of pins; and
c) passing pins through the web to form apertures, thereby forming a plurality of apertures having an inner surface that differ in properties, characteristics or appearance from a surface of the web adjacent to the aperture.

16. The method of claim 15, wherein the nonwoven web is bonded to at least one other web selected from a nonwoven and a film to form a laminated web.

17. The method of claim 16, wherein the film is selected from flat films and three-dimensional formed films.

18. The method of claim 15, wherein the web comprises a three-dimensional apertured web.

19. The method of claim 15, wherein the apertures comprise 20-40% of the total area of the web.

20. The method of claim 15, wherein the inner surface of at least some of the apertures comprises a surfactant, whereby the inner surface is more hydrophilic than the surface of the web adjacent to the apertures.

21. (canceled)

22. The method of claim 20, wherein the surfactant comprises Silastol® PST.

23. The method of claim 15, wherein the web is selected from airthrough bonded, carded thermobonded, spunbonded, meltblown, and spunbond-meltblown-spunbond nonwoven webs.

24. The method of claim 23, wherein the web comprises fibers selected from polyethylene, polypropylene and combinations thereof.

25. The method of claim 15, wherein the web comprises bi-component fibers of polyethylene and polypropylene.

26. (canceled)
